(19) United States
(12) Patent Application Publication
(10) Pub. No.: US 2024/0286935 A1
(43) Pub. Date: Aug. 29, 2024

(54) REMOVAL OF HEAT STABLE AMINE SALTS FROM LIQUID STREAMS AND RELATED PROCESSES

(71) Applicant: ELECTROSEP INC., League City, TX (US)

(72) Inventor: Paul PARISI, League City, TX (US)

(73) Assignee: ELECTROSEP INC., League City, TX (US)

(21) Appl. No.: 18/566,458

(22) PCT Filed: May 17, 2022
(86) PCT No.: PCT/CA2022/050772

§ 371 Date: Dec. 1, 2023

Related U.S. Application Data
(60) Provisional application No. 63/195,261, filed on Jun. 1, 2021.

(51) Int. Cl. C02F 1/469; B01D 61/44; B01D 61/48; B01D 61/54; C02F 1/00; C02F 101/38

(52) U.S. Cl. CPC C02F 1/4695; B01D 61/445; B01D 61/48; B01D 61/54; C02F 1/008; C02F 2101/38; C02F 2209/01; C02F 2209/05

(57) ABSTRACT

Processes for removing heat stable amine salts from a contaminated aqueous amine solution are proposed comprising passing a feedstream of the contaminated aqueous amine solution in an electrodialysis zone comprising at least one repeat unit with an amine solution compartment for receiving the feedstream, a waste compartment, and an anion source compartment receiving an anion source stream or a bi-polar membrane disposed for providing anions balancing the heat stable anions. Monitoring of an anion source-related parameter being correlated to the anion source concentration of the anion-depleted source stream, or of a waste parameter being correlated to an acid concentration of the waste stream, is performed to further adjust an addition of the anion source or a removal of the waste stream in accordance with the monitored parameter.

### TECHNICAL FIELD

The present techniques relate to the removal of heat stable amine salts from liquid streams, and more specifically, to processes for converting an amine in salt form to an amine in free base form, and removing an anion of the heat stable amine salt as a salt of the associated base that has been added to a modified electrodialysis zone. This patent invention will cover methods to properly control the addition of base to the electrodialysis system and also the proper method to control the discharge of material from the waste stream in order to control the desired concentration of material in this stream.

### BACKGROUND

A wide variety of absorption processes have been proposed for removing acid gases such as, for example, carbon dioxide, hydrogen sulphide and sulphur dioxide from process gas streams using absorbents comprising amines.

Such absorption processes typically involve passing the process gas stream containing one or more of the acid gases to an absorption zone wherein it is contacted with a lean solvent comprising the amine absorbent. A product gas stream, depleted in the acid gases relative to the process gas stream, is withdrawn from the absorption zone as a product. A rich solvent stream comprising the amine absorbent and the absorbed acid gases is also withdrawn from the absorption zone and passed to a regeneration zone, e.g. a stripping column, wherein the absorbed acid gases are desorbed from the solvent to provide a tail gas stream comprising the acid gases and the lean solvent stream herein before described.

A common problem in such acid gas absorption processes is that heat stable salts of the amine are often formed during one or both of the absorption and regeneration steps as a by-product. Heat stable salts of the amine can be formed, for example, when strong acids such as hydrochloric acid or sulphuric acid are present in the process gas.

Heat stable salts of the amine can also be formed when sulphite anions are oxidised to sulphate anions when removing SO₂ from the process gas according to an amine-based recovery processes. Typical anions which form heat stable salts and which are referred to as heat stable anions, include, for example, sulphate anions, thiosulphate anions, polythionate anions, thiocyanate anions, acetate anions, formate anions, nitrate anions, chloride anions, oxalate ions and in addition for amines suitable for H₂S and CO₂ scrubbing, sulphite anions. Heat stable salts generally do not have absorption capacity for the acid gases and are not regenerable under the conditions of the process. Therefore, the level of heat stable salts needs to be controlled in order to retain an adequate degree of absorption capacity for the acid gases.

Electrodialysis has been proposed as a method for removing heat stable amine salts from amine containing streams. In a typical electrodialysis process, such as the one described in U.S. Pat. No. 5,910,611, caustic, e.g., sodium hydroxide, is added to the stream containing the heat stable salt of the amine in order to dissociate the heat stable anion (e.g. sulfate anion) from the heat stable salt and provide an amine in free base form (deprotonated) and a simple heat stable salt, e.g., sodium sulphate. The simple heat stable salt is then separated by conventional electrodialysis wherein the charged ions permeate through anion- and cation-selective membranes. The amine in free base form, which is non-ionic, does not permeate through the membranes and is discharged from the electrodialysis zone as a product. Often, conventional electrodialysis processes can operate in a batch mode wherein the process streams are recirculated until the desired amount of heat stable salts is removed.

Certain problems can result from the use of electrodialysis processes such as described above. For example, since the amine product from the electrodialysis zone is provided in free base form, it can have excessive volatility which can lead to solvent losses during absorption. In addition, when the process is operated in a batch mode, the pH and ionic strength within the compartments of the electrolysis zone vary with the discontinuous operation. As a result, the membranes in the electrodialysis zone often experience shrinking and swelling and, ultimately, are subject to mechanical failure. Moreover, to the extent that the amine is not converted to free base form in the caustic treatment step, there can be substantial losses of the amine due to permeation through the membranes in the electrodialysis zone. In addition, there can be significant losses through the membranes as a result of osmotic forces in the conventional electrodialysis process.

An alternative electrodialysis process is described in U.S. Pat. No. 6,517,700 and achieves the removal of the heat stable anion by substituting the heat stable anion with a regenerable non-heat stable anion in a modified electrodialysis zone. In this process, the regenerable anion is introduced into the electrodialysis stack as a base, in which the feed base (for example NaOH) has first been separated in a cell in the electrodialysis stack into its constituents Na⁺ and OH⁻. The Na⁺(cation) is subsequently transferred in the electrodialysis process directly to the waste stream, while the OH⁻(anion) is transferred into the feed amine stream. In the amine feed stream the anion (OH⁻) can react directly with the protonated amine to form free base amine. In this same amine stream, in order to maintain electrical neutrality an equivalent quantity (equivalents) of anions are transferred across a membrane to the waste stream where it is neutralized with the cation (Nat) to form a neutral waste stream. Reacting the protonated amine directly with the base anion (OH) is more efficient and effective than adding the full base molecule (NaOH) to the amine stream in that the sodium which is undesirable in the amine stream does not have to be subsequently removed. As the amine stream in the electrodialysis configuration is bounded by anionic membranes and that the amine is neutralized in situe, amine losses and overall operating efficiencies are improved.

However, excess or deficient quantity of base can be fed to the process that over time will render the process unstable and or inoperable.

There is thus still a need for improved techniques that enhance stability of operation for dissociating heat stable amine salts from amine streams.

### SUMMARY

There are provided herein a process for converting heat stable amine salts to free base amine and non-amine salts. The proposed process implementations utilize a modified electrodialysis zone being fed with a base such as caustic, in order to convert heat stable amine salts in an amine solution to salts of the base other than the amine in which they were originally associated with and amine in free base form. The proposed process implementations can particularly include controlling at least one of a feed (mass and flow rate) of the base to the process, and a discharge (mass and flowrate) of the base anion in a waste stream to result in enhanced stability of operation. The present techniques can provide a high degree of recovery of the amine in the electrodialysis zone, and can be highly integrated with acid gas-absorption process.

In one aspect, there is provided a process for removing heat stable amine salts from a contaminated aqueous amine solution. The process includes:
passing a feedstream of the contaminated aqueous amine solution comprising an amine in salt form having heat stable anions associated therewith to an electrodialysis zone having a cathode compartment, an anode compartment and at least one repeat unit, wherein the at least one repeat unit comprises:
   an anion source compartment disposed between the cathode compartment and the anode compartment,
   a amine solution compartment for receiving the feedstream and disposed between the anion source compartment and the anode compartment, and
   a waste compartment disposed between the amine solution compartment and the anode compartment;
passing an anion source stream to the anion source compartment, the anion source stream comprising an anion source that provides anions for balancing the heat stable anions;
applying a direct current potential transversely across each compartment, the current being effective to cause (i) amine cations to dissociate from the amine in salt form in the amine solution compartment; (ii) the anions to dissociate from the anion source in the anion source compartment and pass into the amine solution compartment; (iii) heat stable anions to dissociate from the amine in salt form in the amine solution compartment and pass into the waste compartment;
discharging from the amine solution compartment a product stream comprising at least a portion of the amine in free base form or in a regenerable form in which the level of heat stable amine salts has been lowered with respect to the contaminated aqueous solution;
discharging from the anion source compartment an anion source depleted stream having an anion source concentration that has been lowered with respect to the anion source stream;
monitoring an anion source-related parameter of the anion-depleted source stream or of the anion source stream, the anion-related parameter being correlated to the anion source concentration of the anion-depleted source stream;
adding an amount of anions to the anion source depleted stream to form a replenished anion source stream that is fed to the anion source compartment as at least part of the anion source stream, wherein the adding comprises adjusting the amount of anions to be added in accordance with the monitored parameter to maintain the anion source concentration at a set point in the anion source stream.

For example, the monitored parameter being correlated to the anion source concentration can be pH. For example, the monitored parameter being correlated to the anion source concentration can be conductivity. For example, the monitored parameter being correlated to the anion source concentration can be density.

In some implementations, the passing the anion source stream can include feeding the anion source depleted source stream to a source tank and discharging a replenished anion source stream from the source tank for supplying to the anion source compartment. Optionally, the adding of the amount of anions to the anion-depleted source stream comprises supplying a concentrated anion source stream comprising the anions into the source tank. Further optionally, the adding of the amount of anions to the anion-depleted source can be performed via an additional assembly that includes a pipe and a valve and/or a pump that is in fluid communication with the source tank. For example, the adjusting of the amount of the anions can be performed automatically via a controller that receives the monitored anion source-related parameter as input and actuates the valve and/or the pump of the additional assembly accordingly. For example, the monitoring of the anion source-related parameter can be performed in the source tank.

In some implementations, the monitoring of the anion source-related parameter can be performed in-line in the anion-depleted source stream or the anion source stream.

In some implementations, the monitoring of the anion source-related parameter can include sampling the anion source depleted stream or the anion source stream, and measuring the anion source-related parameter of a sample.

In some implementations, the process can further include:
discharging a waste stream from the waste compartment, the waste stream comprising a salt or an acid resulting from the association of cations that dissociated from the anion source, and of the heat stable anions that dissociated from the amine in salt form;
monitoring a waste parameter that is correlated to a salt concentration or an acid concentration of the waste stream;
removing a portion of the waste stream in accordance with the monitored waste parameter to form a depleted waste stream, wherein the removal comprises adjusting the portion to maintain the salt concentration or the acid concentration at another set point in the depleted waste stream; and
recycling at least a part of the depleted waste stream as a feed to the waste compartment.

For example, the waste parameter can be pH. For example, the waste parameter can be conductivity. For example, the waste parameter can be density. For example, the monitoring of the waste parameter is performed in-line in the waste stream that is discharged from the waste compartment.

In some implementations, the anion source can be a base, a salt or an acid, for providing a heat regenerable anion or a non-regenerable anion. For example, the base can be selected from the group consisting of alkali metal oxides, alkali metal hydroxides, alkaline earth oxides, alkaline earth hydroxides, metal oxides and metal hydroxides. For example, the anion source can be selected from the group consisting of alkali metal salts and alkaline earth metal salts, providing heat regenerable anions. For example, the anion source can include acid providing heat regenerable anions.

In another aspect, there is provided a process for removing heat stable amine salts from a contaminated aqueous amine solution. The process includes:
passing a feedstream of the contaminated aqueous amine solution comprising an amine in salt form having heat stable anions associated therewith to an electrodialysis zone having a cathode compartment, an anode compartment and at least one repeat unit, wherein the at least one repeat unit comprises:
   an anion source compartment disposed between the cathode compartment and the anode compartment,
   a amine solution compartment for receiving the feedstream and disposed between the anion source compartment and the anode compartment, and
   a waste compartment disposed between the amine solution compartment and the anode compartment;
passing an anion source stream to the anion source compartment, the anion source stream comprising an anion source that provides anions for balancing the heat stable anions;
applying a direct current potential transversely across each compartment, said current being effective to cause (1) amine cations to dissociate from the amine in salt form in the amine solution compartment; (2) the anions to dissociate from the anion source in the anion source compartment and pass into the amine solution compartment; (3) heat stable anions to dissociate from the amine in salt form in the amine solution compartment and pass into the waste compartment;
discharging from the amine solution compartment a product stream comprising at least in part the amine in free base form or in a regenerable form in which the level of heat stable amine salts has been lowered with respect to the contaminated aqueous solution;
discharging a waste stream from the waste compartment, the waste stream comprising a salt or an acid resulting from the association of cations that dissociated from the anion source and the heat stable anions that dissociated from the amine in salt form;
monitoring a waste parameter being correlated to a salt concentration or an acid concentration of the waste stream;
removing a portion of the waste stream in accordance with the monitored waste parameter to form a depleted waste stream, wherein the removal comprises adjusting the portion to maintain the salt concentration or the acid concentration at a set point in the depleted waste stream; and
recycling at least a part of the depleted waste stream as a feed to the waste compartment.

In some implementations, the anion source is a base, a salt or an acid, for providing a base anion, a heat regenerable anion or a non-regenerable anion. For example, the base can be selected from the group consisting of alkali metal oxides, alkali metal hydroxides, alkaline earth oxides, alkaline earth hydroxides, metal oxides and metal hydroxides. For example, the anion source can be selected from the group consisting of alkali metal salts and alkaline earth metal salts, for providing heat regenerable anions. For example, the anion source can be an acid for providing heat regenerable anions.

In another aspect, there is provided a process for removing heat stable amine salts from a contaminated aqueous amine solution. The process includes:
passing a feedstream comprising an amine in salt form having heat stable amine anions associated therewith to an electrodialysis zone having a cathode compartment, an anode compartment and at least one repeat unit, the at least one repeat unit comprising:
   a amine solution compartment receiving the feedstream and disposed between the cathode compartment and the anode compartment,
   a waste compartment disposed between the amine solution compartment and the anode compartment, and
   a bi-polar membrane disposed between the amine solution compartment and the waste compartment;
applying a direct current potential transversely across each compartment, said current being effective to cause (1) amine cations to dissociate from the amine in salt form in the amine solution compartment, (2) hydroxyl anions to be generated in the bi-polar membrane and pass into the amine solution compartment, (3) heat stable anions to dissociate from the amine in salt form in the amine solution compartment and pass into the waste compartment, and (4) protons to be generated in the bi-polar membrane and pass into the waste compartment;
discharging a product stream from the amine solution compartment, the product stream comprising at least in part an amine in free base form in which the level of heat stable amine salts has been lowered;
discharging a waste stream from the waste compartment, the waste stream comprising an acid resulting from the association of the protons generated in the bi-polar membrane and the heat stable anions that dissociated from the amine in salt form,
monitoring a waste parameter being correlated to an acid concentration of the waste stream,
removing a portion of the waste stream in accordance with the monitored waste parameter to form a depleted waste stream, wherein the removal comprises adjusting the portion to maintain the acid concentration at a set point in the depleted waste stream; and
recycling at least a part of the depleted waste stream as a feed to the waste compartment.

A process for removing heat stable amine salts from a contaminated aqueous amine solution, the process comprising:
passing a feedstream comprising an amine in salt form having heat stable amine anions associated therewith to an electrodialysis zone having a cathode compartment, an anode compartment and at least one repeat unit, the at least one repeat unit comprising:
   a amine solution compartment receiving the feedstream and disposed between the cathode compartment and the anode compartment,
   a waste compartment disposed between the amine solution compartment and the anode compartment, and
   a bi-polar membrane disposed between the amine solution compartment and the waste compartment;
applying a direct current potential transversely across each compartment, said current being effective to cause (1) amine cations to dissociate from the amine in salt form in the amine solution compartment, (2) hydroxyl anions to be generated in the bi-polar membrane and pass into the amine solution compartment, (3) heat stable anions to dissociate from the amine in salt form in the amine solution compartment and pass into the waste compartment, and (4) protons to be generated in the bi-polar membrane and pass into the waste compartment;
discharging a product stream from the amine solution compartment, the product stream comprising at least in part an amine in free base form in which the level of heat stable amine salts has been lowered;
discharging a waste stream from the waste compartment, the waste stream comprising an acid resulting from the association of the protons generated in the bi-polar membrane and the heat stable anions that dissociated from the amine in salt form,
monitoring a waste parameter being correlated to an acid concentration of the waste stream,
removing a portion of the waste stream in accordance with the monitored waste parameter to form a depleted waste stream, wherein the removal comprises adjusting the portion to maintain the acid concentration at a set point in the depleted waste stream; and recycling at least a part of the depleted waste stream as a feed to the waste compartment.

For example, the waste parameter can be pH. For example, the waste parameter can be conductivity. For example, the waste parameter can be density.

In some implementations, recycling at least part of the depleted waste stream can include feeding the waste stream to a waste tank and discharging the at least a portion of the waste-depleted stream from the waste tank. For example, the removal of the portion of the waste stream can include withdrawing the portion of the waste stream from the waste tank. Optionally, the withdrawal of the portion of the waste stream from the waste tank can be performed with a control valve or a metering pump that is in fluid communication with the waste tank via the dedicated line. Further optionally, the adjusting of the portion of the waste stream can be performed automatically via a controller that receives the monitored waste parameter as input and actuates the control valve or the metering pump accordingly.

In some implementations, the monitoring of the waste parameter can be performed in-situ in the waste tank receiving the waste stream.

In some implementations, the monitoring of the waste parameter can be performed in-line in the waste stream that is discharged from the waste compartment.

In some implementations, the monitoring of the waste parameter can include sampling the waste stream and measuring the waste parameter of a sample.

In some implementations, the process can further include varying the set point in accordance with a feed rate of the feedstream, a concentration of the amine in salt form in the feedstream, or an operating temperature in the electrodialysis zone.

While the invention will be described in conjunction with example embodiments and implementations, it will be understood that it is not intended to limit the scope of the invention to such embodiments or implementations. On the contrary, it is intended to cover all alternatives, modifications and equivalents as may be included as defined by the present description. The objects, advantages and other features of the present invention will become more apparent and be better understood upon reading of the following non-restrictive description of the invention, given with reference to the accompanying drawings.

### BRIEF DESCRIPTION OF THE DRAWINGS

Implementations of the present processes and systems are represented in and will be further understood in connection with the following figures.

FIG. 1 illustrates a process flow diagram in which an electrodialysis unit is utilized in the context of a gas treating process to remove heat stable salts.

FIG. 2 illustrates a process flow diagram in accordance with the of the present invention wherein a heat stable amine salt is converted into free base amine and a non-amine salt.

FIG. 3 illustrate a second variation of the flow diagram in accordance to the present invention wherein a heat stable amine salt is converted into free base amine and a non-amine acid.

FIG. 4 illustrates a control system that is utilized to monitor an anion source related parameter that is correlated with an anion source concentration and a waste parameter that is correlated with a waste concentration, and to control the feed rate of a concentrated anion source stream to maintain a desired concentration of anion source in an anion source stream, and the withdrawal rate of a waste stream to maintain a desired concentration of waste (salt or acid) in the waste stream.

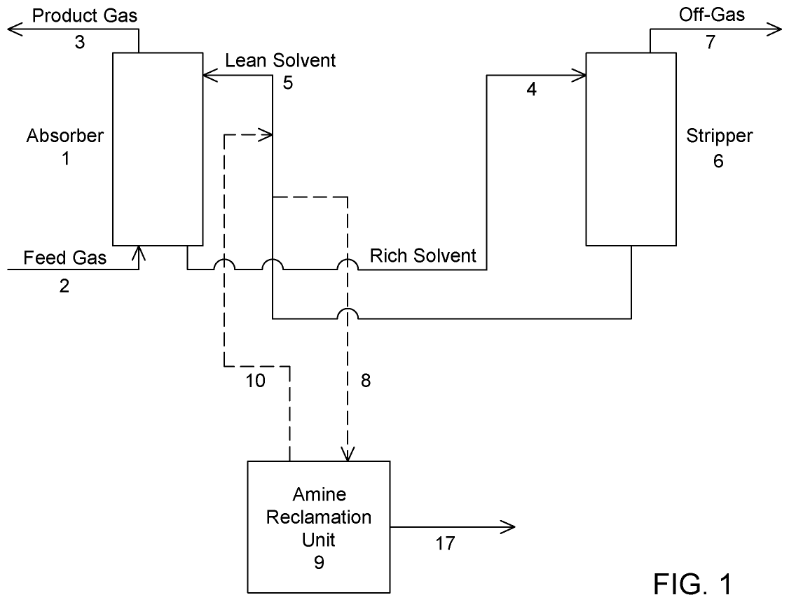

FIGS. 1, 2, 3 and 4 illustrates a process flow diagram in accordance with the present invention. The process flow diagram is provided for illustrative purposes and are not intended to limit the scope of the claims which follow. Those skilled in the art will recognize that the process flow diagram does not illustrate various common pieces of process equipment such as, for example, heat exchangers, pumps, compressors, distillation columns, heaters, process control systems and the like.

While the present techniques will be described in conjunction with example embodiments, it will be understood that it is not intended to limit the scope of the invention to these embodiments. On the contrary, it is intended to cover all alternatives, modifications and equivalents as may be included as defined by the appended claims.

### DETAILED DESCRIPTION

Feed streams suitable for use in accordance with the present techniques generally include any liquid stream comprising an amine in a salt form (protonated form) and heat stable anions associated therewith. This association can be referred as a heat stable salt (HSS) and the amine in the salt/protonated form can be referred to herein as a heat stable amine salt (HSAS) or a heat stable salt of the amine. The feed stream encompassed herein can also be referred to as a contaminated amine solution including contaminants, with the contaminants including the amine in salt form that can be removed according to the presently described process and system implementations.

Typically, the feed stream is aqueous and also comprises at least in part an amine in free base form (with a conjugate base) and at least one heat stable amine salt. The total concentration of the heat stable amine salt(s) is typically from about 0.1 wt % to about 25 wt % based on the total feedstream. For example, the concentration of heat stable amine salts in the feed stream deriving from hydrogen sulfide and carbon dioxide acid gas absorption processes is often from about 1 wt % to about 5 wt %. In another example, the concentration of heat stable amine salts in the feed stream deriving from sulfur dioxide acid gas absorption processes is often from about 1 wt % to about 15 wt %. The concentration of the amine in free base form in the feed stream can be from about 5 wt % to about 60 wt %, optionally from about 20 wt % to 50 wt %. The concentration of water, when present, typically comprises the balance of the feed stream, and can optionally be, from about 30 wt % to about 95 wt %, and, further optionally from about 40 wt % to about 70 wt %, based on the total weight of the feed stream. In some implementations, the feed stream can include small amounts, e.g., less than about 2 wt %, of other ingredients such as, for examples, antifoam or antioxidant agents.

The feed stream can thus be a contaminated amine solution produced via absorption of acid gas and withdrawn from a solvent circulation loop of an acid gas absorption process. Referring to the example implementation of FIG. 1, a process gas comprising hydrogen sulfide, hydrochloric acid with the balance comprising water vapor, methane, ethane and nitrogen is passed into the absorption zone 1 via feed line 2. In the absorption zone 1, the process gas is contacted with a lean solvent stream that is counter-currently supplied to the absorption zone 1 via line 5. For example, the lean solvent stream can be an amine solution comprising diethanolamine, with the balance being mostly water. The absorption zone 1 can be maintained at temperature from 20° C. to 60° C., and a pressure from 1 atmosphere to 150 atmospheres. For example, the absorption zone can be defined by a packed tower or a spray scrubber, the details of which are known to those skilled in the art. Other types of absorption apparatus could be utilized, as it is not critical to the present invention.

Still referring to FIG. 1, during absorption of the hydrogen sulfide from the process gas in absorption zone 1, heat stable salts of amine, i.e. having heat stable chloride anions associated therewith, are formed. A product gas stream at least partially depleted in hydrogen sulfide relative to the process gas stream (feed) is discharged from absorption zone 1 via line 3. A rich solvent stream comprising absorbed hydrogen sulfide and the amine is discharged from absorption zone 1 via line 4 and passed to a regeneration zone 6. During regeneration, hydrogen sulfide is liberated from the solvent stream (amine). The regeneration zone 6 can be a distillation column operated under steam stripping conditions at a temperature form about 75° C. to about 150° C. and a pressure from about 1 atmosphere to about 3 atmospheres, the details of which are known to those skilled in the art. The particular method and apparatus for regeneration is not critical to the present invention. It is further known for heat stable salts to form in the regeneration zone as well. A regeneration overhead stream comprising hydrogen sulphide and water is discharged from the regeneration zone 6 via line 7. A regenerated amine stream, also referred to as lean amine stream, is discharged from the regeneration zone 6 via line 5. A slipstream is taken from the lean amine stream via line 8, and further introduced into an electrodialysis zone 9 for conversion of at least a portion of the amine in salt form (HSAS) into the amine in free base form. The slipstream 8 is the feed stream to the amine reclamation unit 9 as described and claimed herein. The product stream being at least partially depleted in heat stable amine salts is discharged from the electrodialysis zone via line 10 and returned to the lean amine stream 5 for reuse in the absorption zone 1.

Although the process based on FIG. 1 has been described in relation to hydrogen sulphide as acid gas and diethanolamine as the amine, one skilled in the art will readily understand that other types of acid gases and other types of amines/amides could be utilized without departing from the scope of the present techniques.

In some implementations, the feed stream to the amine reclamation unit can comprise a slipstream of the lean amine stream, i.e., regenerated solvent, from the steam stripping column, of an acid gas absorption process. For example, the feed stream to the amine reclamation unit can consist of the slipstream of the lean amine stream. The amine can be, for example an aliphatic, aromatic, heterocyclic amine and amide. Typical alkanol amines suitable for use in accordance with the present processes include monoethanolamine, diethanolamine, triethanolamine and methyldiethanolamine, for example. Typical alkyleneamines include for example, ethylene diamine and alkyl derivatives thereof. Typical aromatic amines include, for example aniline and xylidine. Typical heterocyclic amines include, for example, piperazine and derivatives thereof. Typical amides, include piperazinone. The acid gas can be hydrogen sulphide, carbon dioxide, or sulfur dioxide. When hydrogen sulphide is present in the process gas stream, its concentration can be from about 10 to 50,000 parts per million volume (“ppmv”), optionally up to 30 volume percent or more. When carbon dioxide is present in the process gas stream, its concentration typically ranges from about 2 to 30 volume percent, although levels of carbon dioxide as high as about 90 volume percent or more are not uncommon. When sulfur oxides are present in the process gas stream, i.e., sulfur dioxide and/or sulfur trioxide, their total concentration typically ranges from about 500 ppmv to 50 vol %, although levels as high as 70 vol % or more are possible. The process gas stream can comprise other ingredients such as, for example nitrogen, water, oxygen, light hydrocarbons, and sulfur derivatives of light hydrocarbons, e.g., mercaptans.

Heat stable amine salts often form during absorption or regeneration in acid gas absorption processes. As used herein, the term “heat stable amine salt(s)” means any amine in salt form which is not regenerated (converted into free form) under the regeneration conditions of the process. For example, typical conditions for regenerating the amine in salt form include steam stripping in a distillation column at a temperature of from about 75° C. to 160° C., and at a pressure of about 0.2 to 3 atmospheres. Heat stable amine salts are also known to those skilled in the art as those salts whose anions correspond to non-volatile or strong acids relative to the strength of the acid gases being regenerably absorbed. Those skilled in the art can determine which anions can form heat stable anions in association with heat stable amine salt(s) depending on the particular amine and acid gas. Typical anions which form heat stable anions, include for example, sulphate anions, nitrate anions, thiosulphate anions, thiocyanate anions, halide anions, nitrite anions, polythionate anions, acetate anions, formate anions, oxalate anions and mixtures thereof. Sulphite anions, which are heat regenerable anions can be heat stable, for example, when present in a hydrogen sulphide or carbon dioxide absorption process.

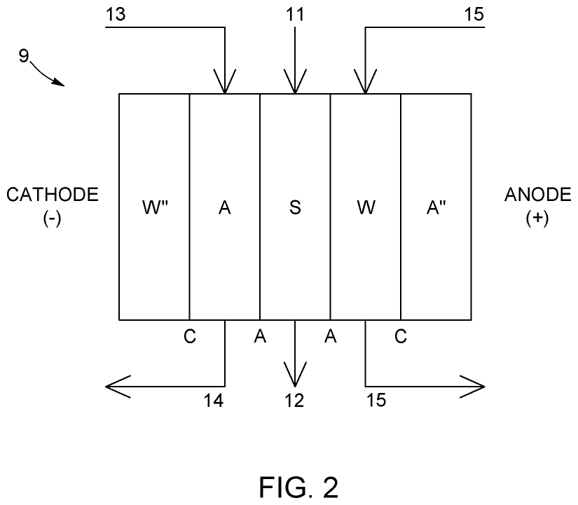

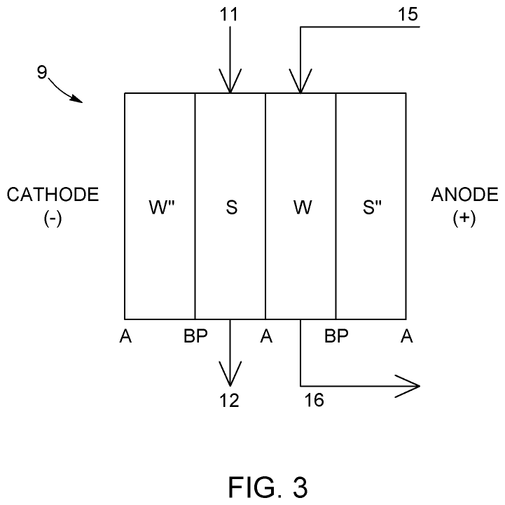

FIGS. 2 and 3 illustrate two example implementations of an electrodialysis zone that can be implemented in the process flow diagram of FIG. 1 where a heat stable amine salt, i.e., sulphate salt, can be converted to a free base amine.

Referring to the example implementation of FIG. 2, the electrodialysis zone 9 comprises a cathode compartment, an anode compartment and at least one repeat unit, wherein each repeat unit contains an anion source compartment (A), an amine solution compartment (S) and a waste compartment (W). Also illustrated in electrodialysis zone 9 are anion source compartment (A″) and a waste compartment (W″) from adjacent repeat units. The anion source compartment (A) and the amine solution compartment (S) are separated by an anion selective membrane. The amine solution compartment (S) and the waste compartment (W) are separated by an anion selective membrane. The waste compartment (W″) of an adjacent repeat unit and the anion source compartment (A) are separated by a cationic selective membrane. A direct current potential is passed transversely across each compartment in electrodialysis zone. A contaminated amine solution (containing heat stable amine salts) is fed as the feed stream to each amine solvent compartment via line 11 and returned to the acid gas absorption process via line 12 which will feed into line 10 directly or via an intermediate storage tank (not illustrated). Alternatively, the passing of the feed stream could be operated continuously, in a batch mode (periodically) or on a once through basis.

As used herein, the term “cationic selective membrane” means a membrane which will selectively permeate cations over anions. As used herein, the term “anionic selective membrane” means a membrane which will selectively permeate anions over cations. In general, details concerning such membranes are known in the art. Any suitable or conventional cationic ion exchange membranes and anionic ion exchange membranes can be used in the electrodialysis cell. However, preferred membranes include those which are polyvinylchloride-based. Examples of preferred cationic membranes include Neosepta CMX membranes available from Astom Ltd. Examples of anionic selective membranes include Neosepta and AMX membranes.

The electrodialysis zone can contain from about 10 to 500 repeat units, and optionally can contain from about 40 to 200 repeat units. The streams that are fed to the compartments of each repeat unit generally flow through the compartments in a co-current direction relative to each other. Also, the inlets and outlets of common compartments, e.g., product compartments, are typically connected by a common manifold system. Further details concerning operating conditions and the design of electrodialysis zones are known to those skilled in the art.

Referring to FIG. 2, a base or a source of regenerable anions (referred to as the anion source, or anion source solution), such as caustic, is circulated through the electrodialysis zone via lines 13 and 14. The anion source can be fed to the anion source department to provide anions passing into the product feed compartment (S) via the anionic selective membrane, and thereby providing cations in the adjacent waste compartment (W″) via the cationic selective membrane and producing waste. If an acid that is a source of regenerable anions, is fed to the anion source compartment, then an acid waste will be produced in the waste compartment instead of a salt solution. Thus, a salt or acid waste solution is circulated in the electrodialysis zone 9 via lines 15 and 16. Both the anion source solution and waste solution can be circulated on a once through basis, recirculated continuously or recirculated in a batch mode (periodically).

In some implementations, the anion source stream can include a base which will dissociate into a heat regenerable anion or a heat stable anion. The anions of the provided base, e.g. hydroxide, permeates through the anionic selective membrane and pass into the product compartment. Typical bases include alkali metal oxides and hydroxides, alkaline earth oxides and hydroxides and metal oxides and hydroxides. Examples of bases include, sodium oxide or hydroxide and potassium oxide or hydroxide, beryllium hydroxide and zinc hydroxide. Mixtures of bases can be used.

In other implementations, the anion source stream can include an acid which provides heat regenerable anions, such as a reflux from the amine absorption unit including H₂S solution that can comprise carbonic acid and sulphurous acid.

In other implementations, the anion source stream can include a salt which provides heat regenerable anions, such as alkali metal salts or alkaline earth metal salts.

The amine feed stream is passed into the amine solution compartment wherein amine cations can dissociate from the heat stable anions. The heat stable anions permeate through the anionic selective membrane to the waste compartment. For example, still referring to FIG. 2, in the amine solution compartment (S), amine cations dissociate from the heat stable anions, such as chloride. The heat stable anions, such as chloride, permeate through the anionic selective membrane to the waste compartment (W). In the anion source compartment (A), base anions such as hydroxide anions, can dissociate from base cations such as sodium cations. The hydroxide anions permeate through the anionic selective membrane to the amine solution compartment (S). If a source of heat regenerable anions is used, such as sulphurous acid, sodium sulfite, sodium carbonate, etc., the regenerable anions permeate through the anionic selective membrane to the amine solution compartment (S). In the amine solution compartment, the hydroxide anions combine with the protonated amine cations to form the free base amine and water. From each anion source compartment (A and A″), the sodium cations permeate through the cationic selective membranes to the adjacent waste compartment (W″ and W). A water-containing stream is introduced into each waste compartment (W), with the water-containing stream having an increasing waste concentration when the solution is circulated.

A feed effluent stream, having substantially the same composition as the feed stream except for a reduced concentration of heat stable salts, is discharged from the amine solution compartment (salt-depleted feed or product stream). The product stream comprises the amine in a free base form or in a non-heat stable salt form (when a regenerable anion being fed to the anion source loop), which may contain the amine(s) with heat stable and non-heat stable salts. The amine solvent product stream can be reintroduced into the acid gas recovery process, where the free base amine or amine in with non-heat stable salt will serve to lower the overall level of heat stable salt(s) in the circulating amine solution. Still referring to FIG. 2, the product stream containing some amine in free base form, in addition possibly with some heat stable amine salts, or at least a reduced concentration of heat stable and heat regenerable anions is discharged from the amine solution compartment via line 12. Such product stream can be combined with the lean solvent stream 4 or with the rich solvent stream 5 via line 10 as seen in FIG. 1.

A salt or acid stream comprising the salt or acid of the heat stable anion is discharged from the salt compartment. Typical salts of the heat stable anions include, for example, alkali metal sulphates, alkali metal halides, alkali metal acetates, alkali metal thiocyanates, alkali metal thiosulphates, alkali metal nitrates and nitrites, alkaline earth sulphates, alkaline earth halides, alkaline earth acetates, alkaline earth thiocyanates, alkaline earth thiosulfates, alkaline earth nitrates and nitrites and mixtures thereof. Preferred salts of heat stable anions include sodium sulphate, sodium chloride, sodium acetate, sodium thiocyanate, and sodium thiosulphate. With the third embodiment, the acid of the heat stable anions is produced if an acid is utilized as the source of regenerable anions. Preferably the salts and acids are soluble in the said stream and do not precipitate out of solution. Such precipitation could adversely affect the operation of the electrodialysis zone. A carrier stream, preferably an aqueous carrier, is introduced to the salt compartment in order to control the flow rate and the concentration of the salt or acid in the waste stream. The waste stream can be removed from the process as a product. The feedstream and product stream can be introduced to the electrodialysis zone on a once through basis or on a recycle basis. When the electrodialysis zone is operated on a recycle basis, a portion of the feed effluent stream and the base effluent stream is recycled back to the feed compartment and the base compartment, respectively. Methods of recycling such streams are generally known to those skilled in the art. Typically, however, holding tanks are employed whereby the feedstream and base stream are introduced to their respective holding tanks. By operating in this fashion, it is possible to maintain essentially any desired flow rates within the compartments in the electrodialysis zone even though the actual flow rates of the feedstream and base stream to the holding tanks may be substantially lower. Effluent streams are then withdrawn from the holding tanks at flow rates, which are essentially equivalent to the flow rates of the feedstream in order to maintain steady state concentrations and volumes.

For example, referring to FIG. 2, the waste stream containing salts of heat stable anions such as sodium chloride is discharged from waste compartment (S) via line 16.

Referring to the example implementation of FIG. 3, the electrodialysis zone 9 can comprise a cathode compartment, an anode compartment and at least one repeat unit, wherein each repeat unit contains an amine solution compartment (S), and a waste compartment (w). Also illustrated in the electrodialysis zone 9 are adjacent amine solution compartment (AS) and adjacent waste compartment (W″) from adjacent repeat units. The electrodialysis zone 9 further contains bi-polar-membranes (BP) and anionic selective membranes (A). A direct current potential is passed transversely across each compartment in the electrodialysis zone 9.

Referring to FIG. 3, the contaminated amine solution (that can also be referred to herein slipstream or feed stream) is fed to the amine solution compartment (S) via line 11 to form a product stream that is returned to the gas treating process via line 12. Both the feed and product streams can be recirculated through a tank with make-up and bleed being lines 8 and 10 respectively in FIG. 1. Alternatively, the process could be operated in a batch mode or on a once through basis. In the amine solution compartment (S), amine cations dissociate from the heat stable anions, such as chloride. The heat stable anions, such as chloride permeate through the anionic selective membrane to the waste compartment (W). Hydroxide anions are generated in the bi-polar membranes and permeate into the amine solution compartment (S). In the amine solution compartment (S), the hydroxide anions combine with the protonated amine cations to form free base amine and water. Protons are also generated in the bi-polar membranes and permeate into the waste compartment (W). A water-containing stream is introduced into the waste compartment (W). The product stream containing some amine in free base form in addition possibly with some heat stable amine salts, or at least a reduced concentration of heat stable and heat regenerable anions is discharged from the amine solution compartment via line 12. The product stream can be combined with the lean solvent stream 4 or with the rich solvent stream 5 via stream 10 as seen in FIG. 1. A waste product stream containing acids of heat stable anions such as hydrochloric acid is discharged from waste compartment (W) via line 16 and ultimately from the process via line 17.

Although the invention has been described with respect to specific aspects, those skilled in the art will recognize that other variations are possible within the scope of claims that follow. Those skilled in the art know that electrode rinse solutions are often passed through the anode and cathode compartments to supply anions and cations for electrical conductivity. In the present invention, a portion of the waste stream or a dedicated stream can be used for this purpose.

### Process Control Implementations

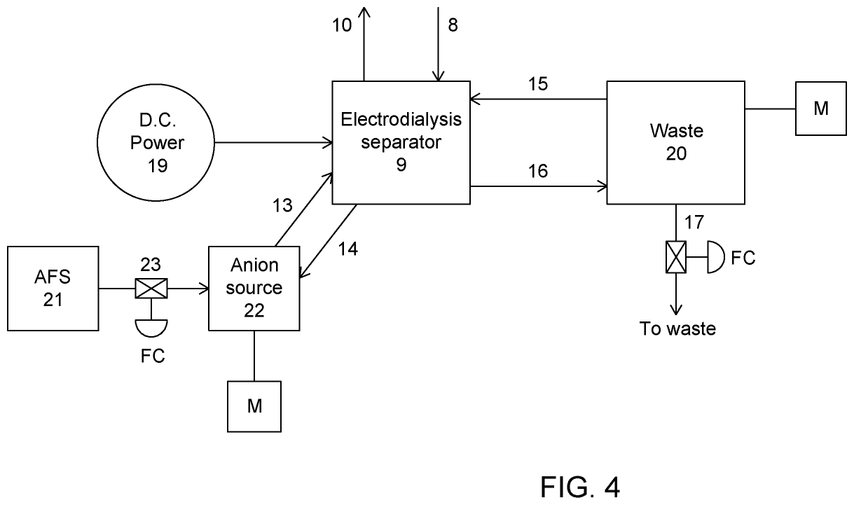

In accordance with the present techniques, referring to FIG. 1, it is possible to maintain the level of heat stable amine salts in the lean solvent feed 5 to the absorption zone 1 of an acid gas absorption process at a level low enough to not substantially interfere with the absorption of the acid gas. There is provided a control system that is operatively connected to the electrodialysis zone 9 and as illustrated for example in FIG. 4.

When the absorbent comprises a monoamine, such as for the absorption of hydrogen sulphide and carbon dioxide or an amide for the absorption of sulfur dioxide, the level of heat stable salts in the regenerated absorbent is preferably less than about 0.25 equivalent of heat stable salt per mole of amine or amide, and more preferably less than about 0.1 equivalent per mole of amine.

When the absorbent comprises a diamine, such as for sulfur dioxide, the level of heat stable salts in the regenerated absorbent is typically less than about 1 equivalent of heat stable salt per mole of diamine, preferably less than about 0.8 equivalent per mole of diamine. For certain special applications, the level of heat stable salts is maintained in the range of 0.5 to 0.9 equivalents per mole or less (ref. U.S. Pat. No. 5,019,361).

Typically, the recovery of amine is at least 80 percent, preferably at least 90 percent and most preferably at least 99 percent. Without being bound to any theory, it is believed that the high recovery is due to factors including the arrangement of the compartments within the electrodialysis zone. For example, in the presently described system of FIG. 2, the amine cations are substantially only able to permeate through the cationic selective membrane between the feed and product compartments. Since the base or anion source compartment is separated from the product compartment and the combined feed-product compartment, by an anionic selective membrane, very little amine cation, e.g. typically less than about 2 percent, is allowed to permeate to the base or anion source compartment. In addition, the free base amine, being of neutral charge, is not influenced by the electric field in the electrodialysis zone, and thus does not tend to permeate from one compartment to another. The free base amine can permeate by osmotic diffusion, but the losses of such to the base or anion source and salt or waste streams can be kept at a minimum by not operating the feed stream and product stream or the amine solvent stream in the alternative embodiment in a recycle mode, or by minimizing the rate of recycling, thus minimizing the concentration of free base amine in these streams.

Controlling the amount of residual heat stable amine salt in the lean solvent feed to the absorption zone is proposed to be based on a relationship between an anion source concentration and a parameter correlated with the anion source concentration, such as at least one of pH, conductivity and other solution characteristics such as colour density. Indeed, at least one of those can be utilized to measure and control the feed rate of the anion source to the anion source compartment or the anion source concentration of the anion source stream to the anion source compartment.

For example, Table 1 indicates the relationship between sodium hydroxide solution concentration and the measured pH and conductivity at ambient temperature. Similar data can be prepared for other substances.

TABLE 1

| NaOH % | 0.5 | 1 | 1.5 | 2 | 5 | 10 | 25 | 50 |
|---|---|---|---|---|---|---|---|---|
| pH | 13.2 | 13.5 | 13.7 | 13.8 | 13.64 | 13.59 | 13.18 | 11.69 |
| Conductivity | 25 | 48 | 73 | 90 | 199.8 | 196.1 | 188.1 | 130.7 |
| (mS/cm) | | | | | | | | |

The hydroxide or equivalent anions to be dissociated in the anion source compartment are generated from a base, salt or acid feed. The feed rate of molecules used to generate the anions in the anion source compartment, being a base such as sodium hydroxide, a salt such as sodium bicarbonate or an acid such as sulphurous acid are controlled by measuring one of or both pH and or conductivity of the feed stream to the anion source compartment and controlling separately the feed rate of source material to the compartment in order to maintain a constant and desired or set point pH and or conductivity.

More particularly, once a desired anion source concentration set-point (related to a desired residual heat stable amine salt concentration in product stream or in lean solvent stream) has been determined, then the process can include monitoring the anion source-related parameter (via measurement of solution conductivity, pH and/or any other measured property, such as density colour, etc. that can then be measured), such that a controlled amount of anion source solution is added to make up the anion source stream before being fed to the anion source compartment of an electrodialysis zone as exemplified in FIG. 2. The controlled amount is adjusted in accordance with the monitored anion source-related parameter. For example, a feed make-up rate of an anion source solution can be adjusted and controlled to maintain the anion source concentration set point in the anion source stream to the anion source compartment. Measurements for the monitoring can be performed in-line or by sampling the stream (anion source stream 13 or anion source depleted stream 14 and measuring the desired property offline. One skilled in the art will readily understand that these measured properties are a function of temperature and thus the desired set points will differ with temperature.

Referring to FIG. 4, the amine solution slipstream 8 can be fed to the electrodialysis separator (9) illustrated in FIGS. 2 and 3 and returned at least partially depleted in heat stable salts via stream 10. During electrodialysis separation, the amine solution can be recirculated or partially recirculated via streams 11 and 12 optionally with or without a tank (not shown). DC power is supplied via a DC power source (19). A source of anions (anion source) is fed to an anion source tank 22 from an outside source of anions 21, such as caustic (sodium hydroxide). The anion source 21 is thus added to the anion source recirculation tank 22 via line 23. The anion source is circulated as the anion source stream into the electrodialysis zone 9 via lines 13 and 14. More particularly, as a feed make up stream of the anion source is fed via line 23 to the anion source tank, the stream flowing via line 14 can be referred to as an anion source depleted stream and the stream flowing via line 13 can be referred to as a replenished anion source stream, ensuring circulation of an anion source stream in anion source compartment at a constant anion source concentration. Recirculation of amines, anion source and waste solution is not critical for this invention. In the design and operation of the electrodialysis stack, one may choose to utilize recirculation or a once through approach or any combination or variation of this approach.

Still referring to FIG. 4, the anion source-related parameter in tank 22 or alternatively in stream 13 or 14 or in one or more of these streams/locations is measured either continuously or by sampling and measuring outside of the unit. Such measured anion source parameter could be stream or solution conductivity, pH, density or any other measurable property that could be correlated to the concentration or activity of the anion source stream. As detailed with respect to FIG. 2 above, an anion source depleted stream 14 having essentially the same composition as the anion stream 13, except for a lower anion source concentration, is discharged from the anion source compartment (A). The monitored anion source-related parameter will thus reflect the lowering in concentration, such that the anion source concentration in anion source stream 13 is controlled and adjusted by addition of the anion source to the anion source recirculation tank 22, via line 23.

Flow or feed rate from the outside anion source (21) to the anion source compartment or to stream 14 or some combination of them is controlled in stream 23 using the monitored anion source-related parameter to maintain a set point concentration. This set-point could be varied depending on outside parameters such as the amine feed rate, the heat stable salt concentration, operating temperature or any other parameter of importance. For example, Table 1 indicates pH and conductivity versus sodium hydroxide concentration at ambient temperature. This method is not limited to the use of sodium hydroxide to any chosen anion source molecule as detailed earlier in this document. Feed of fresh material from the anion source (21) can be fed via stream 23 using a pressurized feed source, a control valve or a metering pump, for example.

In addition, the process can include controlling the waste concentration or amount in the produced waste stream before recirculation thereof. Controlling this parameter allows controlling the concentration of the waste solution circulating the electrodialysis unit and also to control the strength and volume of waste generated (higher strength results in a lower volume for a given removal rate). As per the method used to control the addition of chemical (anion source) to the anion source stream, monitoring of a waste-related parameter can be utilized to control the removal of the waste products (neutral salts or acids) from the waste stream and thus maintain a stable waste concentration at a waste set point. The waste related parameter is a parameter correlated with the waste concentration/content (acid or salt) in the waste stream, and includes pH, conductivity, colour density or any combination thereof.

Still referring to FIG. 4, the waste solution or waste stream is recirculated into the electrodialysis zone via lines 15 and 16. More particularly, the stream withdrawn from the waste compartment of the electrodialysis zone 9 via line 16 can be referred to as the concentrated waste stream, and the stream recirculated to the waste compartment via line 15 can be referred to as a waste depleted stream, ensuring circulation of the waste stream in the waste compartment at a constant waste concentration. Depletion is caused by waste products being withdrawn from the waste circulation loop via line 17.

Control of the waste concentration can apply to the configurations of the electrodialysis zone 9 as exemplified in FIGS. 2 and 3. Circulation of the waste stream comprises controlling a flow or bleed rate of the waste solution/stream via line 17 from a waste solution tank 20 (as seen in FIG. 4), or alternatively from stream 16 or as a portion or all of stream 16. The control can include monitoring the waste related parameter either continuously or by taking samples of stream 17, 16 or 15 or some combination of these streams or from the waste solution tank 20 and adjusting the flow rate or bleed rate via line 17 in accordance with the monitored waste-related parameter to maintain the acid or salt concentration in the waste stream at the given set point. The set-point could be varied depending on the outside parameters such as amine feed rate, the heat stable salt concentration, operating temperature or any other parameter of importance including the desired salt or acid or base concentration in stream 17. Typically, a control valve would be used but other methods such as a variable speed pump could be utilized for example. Although the invention has been described with respect to specific aspects, those skilled in the art will recognize that other variations are possible within the scope of claims that follow.

In the following description, the term “about” means within an acceptable error range for the particular value as determined by one of ordinary skill in the art, which will depend in part on how the value is measured or determined, i.e., the limitations of the measurement system. It is commonly accepted that a 10% precision measure is acceptable and encompasses the term “about”.

It should be understood that any one of the above-mentioned implementations of the processes may be combined with any other of the aspects thereof unless two aspects clearly cannot be combined due to their mutual exclusivity. In addition, the various structural elements of the electrodialysis zone and control system, herein below and/or in the appended Figures, may be combined with any of the processes descriptions appearing herein above, and/or herein below.

1. A process for removing heat stable amine salts from a contaminated aqueous amine solution, comprising:
passing a feedstream of the contaminated aqueous amine solution comprising an amine in salt form having heat stable anions associated therewith to an electrodialysis zone having a cathode compartment, an anode compartment and at least one repeat unit, wherein the at least one repeat unit comprises:
an anion source compartment disposed between the cathode compartment and the anode compartment,
an amine solution compartment for receiving the feedstream and disposed between the anion source compartment and the anode compartment, and
a waste compartment disposed between the amine solution compartment and the anode compartment;
passing an anion source stream to the anion source compartment, the anion source stream comprising an anion source that provides anions for balancing the heat stable anions;
applying a direct current potential transversely across each compartment, the current being effective to cause (i) amine cations to dissociate from the amine in salt form in the amine solution compartment; (ii) the anions to dissociate from the anion source in the anion source compartment and pass into the amine solution compartment; (iii) heat stable anions to dissociate from the amine in salt form in the amine solution compartment and pass into the waste compartment;
discharging from the amine solution compartment a product stream comprising at least a portion of the amine in free base form or in a regenerable form in which the level of heat stable amine salts has been lowered with respect to the contaminated aqueous solution;
discharging from the anion source compartment an anion source depleted stream having an anion source concentration that has been lowered with respect to the anion source stream;
monitoring an anion source-related parameter of the anion-depleted source stream or of the anion source stream, the anion-related parameter being correlated to the anion source concentration of the anion-depleted source stream;
adding an amount of anions to the anion source depleted stream to form a replenished anion source stream that is fed to the anion source compartment as at least part of the anion source stream, wherein the adding comprises adjusting the amount of anions to be added in accordance with the monitored parameter to maintain the anion source concentration at a set point in the anion source stream.

2. (canceled)

3. The process of claim 1, wherein the monitored parameter being correlated to the anion source concentration is conductivity.

4. The process of claim 1, wherein the monitored parameter being correlated to the anion source concentration is density.

5. The process of claim 1, wherein passing the anion source stream to the anion source compartment comprises feeding the anion source depleted source stream to a source tank and discharging a replenished anion source stream from the source tank for supplying to the anion source compartment.

6. The process of claim 5, wherein the adding of the amount of anions to the anion-depleted source stream comprises supplying a concentrated anion source stream comprising the anions into the source tank.

7. The process of claim 6, wherein the adding of the amount of anions to the anion-depleted source is performed via an additional assembly that includes a pipe and a valve and/or a pump that is in fluid communication with the source tank.

8. The process of claim 7, wherein the adjusting of the amount of the anions is performed automatically via a controller that receives the monitored anion source-related parameter as input and actuates the valve and/or the pump of the additional assembly accordingly.

9. The process of claim 5, wherein the monitoring of the anion source-related parameter is performed in the source tank.

10. The process of claim 1, wherein the monitoring of the anion source-related parameter is performed in-line in the anion-depleted source stream or the anion source stream.

11. The process of claim 1, wherein the monitoring of the anion source-related parameter comprises sampling the anion source depleted stream or the anion source stream, and measuring the anion source-related parameter of a sample.

12. The process of claim 1, further comprising:
discharging a waste stream from the waste compartment, the waste stream comprising a salt or an acid resulting from the association of cations that dissociated from the anion source, and of the heat stable anions that dissociated from the amine in salt form;
monitoring a waste parameter that is correlated to a salt concentration or an acid concentration of the waste stream; and
removing a portion of the waste stream in accordance with the monitored waste parameter to form a depleted waste stream, wherein the removal comprises adjusting the portion to maintain the salt concentration or the acid concentration at another set point in the depleted waste stream.

13. (canceled)

14. The process of claim 12, wherein the waste parameter is conductivity.

15. The process of claim 12, wherein the waste parameter is density.

16. The process of claim 12, wherein the monitoring of the waste parameter is performed in-line in the waste stream that is discharged from the waste compartment.

17. The process of claim 1, wherein the anion source is a base, a salt or an acid, for providing a heat regenerable anion or a non-regenerable anion.

18. The process of claim 17, wherein the base is selected from the group consisting of alkali metal oxides, alkali metal hydroxides, alkaline earth oxides, alkaline earth hydroxides, metal oxides and metal hydroxides.

19. The process of claim 17, wherein the anion source is selected from the group consisting of alkali metal salts and alkaline earth metal salts, providing heat regenerable anions.

20. The process of claim 17, wherein the anion source comprises acid providing heat regenerable anions.

21. A process for removing heat stable amine salts from a contaminated aqueous amine solution, comprising:
passing a feedstream of the contaminated aqueous amine solution comprising an amine in salt form having heat stable anions associated therewith to an electrodialysis zone having a cathode compartment, an anode compartment and at least one repeat unit, wherein the at least one repeat unit comprises:
an anion source compartment disposed between the cathode compartment and the anode compartment,
an amine solution compartment for receiving the feedstream and disposed between the anion source compartment and the anode compartment, and
a waste compartment disposed between the amine solution compartment and the anode compartment;
passing an anion source stream to the anion source compartment, the anion source stream comprising an anion source that provides anions for balancing the heat stable anions;
applying a direct current potential transversely across each compartment, said current being effective to cause (1) amine cations to dissociate from the amine in salt form in the amine solution compartment; (2) the anions to dissociate from the anion source in the anion source compartment and pass into the amine solution compartment; (3) heat stable anions to dissociate from the amine in salt form in the amine solution compartment and pass into the waste compartment;
discharging from the amine solution compartment a product stream comprising at least in part the amine in free base form or in a regenerable form in which the level of heat stable amine salts has been lowered with respect to the contaminated aqueous solution;
discharging a waste stream from the waste compartment, the waste stream comprising a salt or an acid resulting from the association of cations that dissociated from the anion source and the heat stable anions that dissociated from the amine in salt form;
monitoring a waste parameter being correlated to a salt concentration or an acid concentration of the waste stream;
removing a portion of the waste stream in accordance with the monitored waste parameter to form a depleted waste stream, wherein the removal comprises adjusting the portion to maintain the salt concentration or the acid concentration at a set point in the depleted waste stream; and
recycling at least a part of the depleted waste stream as a feed to the waste compartment.

22-25. (canceled)

26. A process for removing heat stable amine salts from a contaminated aqueous amine solution, the process comprising:
passing a feedstream comprising an amine in salt form having heat stable amine anions associated therewith to an electrodialysis zone having a cathode compartment, an anode compartment and at least one repeat unit, the at least one repeat unit comprising:
an amine solution compartment receiving the feedstream and disposed between the cathode compartment and the anode compartment,
a waste compartment disposed between the amine solution compartment and the anode compartment, and
a bi-polar membrane disposed between the amine solution compartment and the waste compartment;
applying a direct current potential transversely across each compartment, said current being effective to cause (1) amine cations to dissociate from the amine in salt form in the amine solution compartment, (2) hydroxyl anions to be generated in the bi-polar membrane and pass into the amine solution compartment, (3) heat stable anions to dissociate from the amine in salt form in the amine solution compartment and pass into the waste compartment, and (4) protons to be generated in the bi-polar membrane and pass into the waste compartment;
discharging a product stream from the amine solution compartment, the product stream comprising at least in part an amine in free base form in which the level of heat stable amine salts has been lowered;
discharging a waste stream from the waste compartment, the waste stream comprising an acid resulting from the association of the protons generated in the bi-polar membrane and the heat stable anions that dissociated from the amine in salt form,
monitoring a waste parameter being correlated to an acid concentration of the waste stream,
removing a portion of the waste stream in accordance with the monitored waste parameter to form a depleted waste stream, wherein the removal comprises adjusting the portion to maintain the acid concentration at a set point in the depleted waste stream; and
recycling at least a part of the depleted waste stream as a feed to the waste compartment.

27-37. (canceled)
